(19) United States
(12) Patent Application Publication
(10) Pub. No.: US 2006/0004848 A1
(43) Pub. Date: Jan. 5, 2006

(54) Methods and system for presenting attributes and associations of managed objects

(76) Inventors: Evelyn Louise Williams, Longmount, CO (US); Birgitta Hettler, Schoenaich (DE); Marko Lamot, Velenje (SI); Janko Spasovski, Maribor (SI)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/135,500

(22) Filed: May 24, 2005

Related U.S. Application Data
(60) Provisional application No. 60/573,841, filed on May 25, 2004.

(51) Int. Cl. G06F 17/00

(52) U.S. Cl. 707/103 R

(57) ABSTRACT

Methods and a system are disclosed for presenting attributes and associations of a first object managed within a data model. The attributes and associations can be displayed in a user dialog. According to an exemplary embodiment, a first attribute and a second attribute of the first object and an identity of a second object associated with the first object within the data model are collected from the data model. The first and second attributes and objects each relate to respective application programs configured to use the data model. The first and second attributes are included on a first page of the user dialog, and identities of the first and second objects are included on a second page of the user dialog. A software link is provided between the first and second pages of the dialog to provide automated access to the first and second pages via the link.

### RELATED APPLICATIONS

The present non-provisional application claims priority under 35 U.S.C. § 119(e) of Provisional Application Ser. No. 60/573,841, entitled: Methods And System For Presenting Attributes And Associations of Managed Objects, (Attorney Docket No. 100111124-1), filed May 25, 2004, by Evelyn Williams, Birgitta Hettler, Marko Lamot, and Janko Spasovski, the disclosure of which is hereby incorporated by reference in its entirety.

### BACKGROUND

1. Field of the Invention

The present invention relates to computer system graphical user interfaces (GUIs). More particularly, the present invention relates to methods and a system for presenting attributes and associations of objects managed within a data model.

2. Background Information

Data models provide the foundation upon which software developers can develop, maintain, and extend software application programs. A data model defines both the data (e.g., integer, string, and Boolean types) used by an application program, and the structure of the data (e.g., fields or attributes) within the data model. Data models have differing architectures that define the way in which the data models interact with application programming languages to produce the software application programs. Many data models today employ an object-oriented architecture.

Object-oriented data models include real-world or abstract entities (or objects) that can be coupled together and reused by the application programming languages to produce the software application programs. An object includes both data and programs (or code) to operate on the object data. The data defines the state of the object, and the code defines the behavior of the object. The state of an object includes the set of values (or attributes) defined for the object, and the behavior includes a set of methods and an interface for its invocation. Object-oriented programming involves the invocation of the behavior of an object via message passing to the object using the interface defined for the behavior of the object.

The objects used by application programs in managed systems, such as network management software, can have a large number of object attributes and object associations. Management software typically presents the attributes of an object in a user dialog that is displayable on a computer display terminal. The user dialog, commonly referred to as a properties dialog, typically includes a number of “tabs” that provide access to respective pages in the dialog. Each of the “tabbed” dialog pages present corresponding groups of related attributes. “Tabbed” properties dialogs emphasize the editing or changing of attribute values rather than the viewing of attribute values for a given object.

Recall that an object includes both data (attributes) and programs (code modules) to operate on the data encapsulated within the object. Different application programs executing within the managed system can interface with respective code modules of an object to accomplish various tasks. A code module, and thus an application program that interfaces with that code module, can use only a portion of the attributes encapsulated within the object. As a result, the visibility of the attributes encapsulated within an object to an application program can be limited to the related attributes used by the application program itself. Management software presents these related object attributes in separate properties dialogs or on respective “tabbed” pages of a single properties dialog.

Consequently, management systems having large numbers of application programs can result in a user having to navigate through large numbers of properties dialogs and/or “tabbed” pages of a properties dialog to view all of the attributes for a given object. Such an arrangement emphasizes the importance of labeling the various “tabbed” pages of a dialog with meaningful and descriptive names. If the names are not sufficiently descriptive to indicate to a user that an attribute is presented on particular page, locating the attribute can be difficult. Moreover, presenting attributes in separate dialogs and/or on separate “tabbed” pages can make it difficult for users to identify inconsistencies or conflicts that can exist among the various object attributes.

In managed systems, knowing the associations of an object can be as important as knowing the attributes of the object itself. Yet, it can be difficult for a user to determine the objects within a managed system that are associated with a particular managed object. Part of the difficulty arises from the manner in which object association information is gathered. Typically, this information is separately collected and maintained by the various application programs running within the managed environment. This arrangement can require users to navigate through several different user dialogs, corresponding to each of the various application programs, to collect the object association information that they require.

### SUMMARY OF THE INVENTION

Accordingly, methods and a system are disclosed for presenting attributes and/or associations of an object managed within a data model. The attributes and associations can be displayed in a user dialog.

According to a first exemplary embodiment, a first attribute and a second attribute of an object are collected from the data model. The first and second attributes relate to respective application programs configured to use the data model. The first and second attributes are included on a single page of the user dialog.

According to a second exemplary embodiment, an identity of a second object associated with a first object within the data model is collected from the data model. The first and second objects relate to respective application programs configured to use the data model. Identities of the first and second objects are included on a single page of the user dialog.

According to a third exemplary embodiment, a first attribute and a second attribute of the first object and an identity of a second object associated with the first object within the data model are collected from the data model. The first and second attributes and objects each relate to respective application programs configured to use the data model. The first and second attributes are included on a first page of the user dialog, and identities of the first and second objects are included on a second page of the user dialog. A software link is provided between the first and second pages of the dialog to provide automated access to the first and second pages via the link.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a flowchart illustrating steps for presenting attributes and/or associations of a first object managed within a data model according to exemplary embodiments;

FIG. 2 illustrates a system for presenting attributes and/or associations of a first object managed within a data model, including a first dialog page for presenting object attributes according to exemplary embodiments; and

FIG. 3 illustrates a second dialog page for presenting object associations according to exemplary embodiments.

### DETAILED DESCRIPTION OF THE PREFERRED EMBODIMENTS

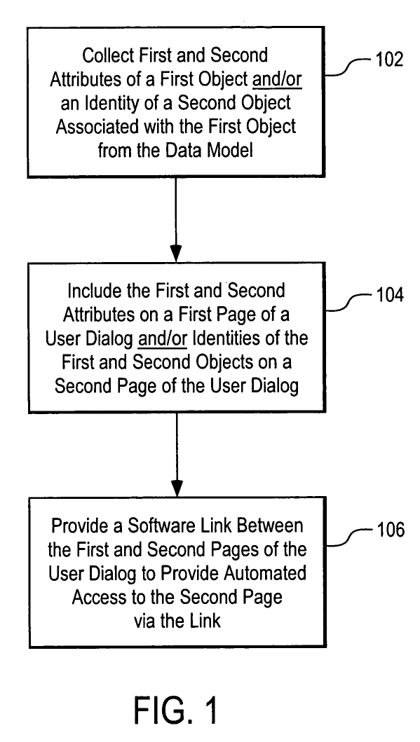

FIG. 1 is a flowchart illustrating the steps for presenting attributes and/or associations of a first object managed within a data model, the attributes and associations being displayable in a user dialog. As such, FIG. 1 depicts the steps of three separate embodiments, namely, the steps for presenting attributes, associations, and both attributes and associations of a first object managed within a data model. The attributes and associations are displayable in a user dialog.

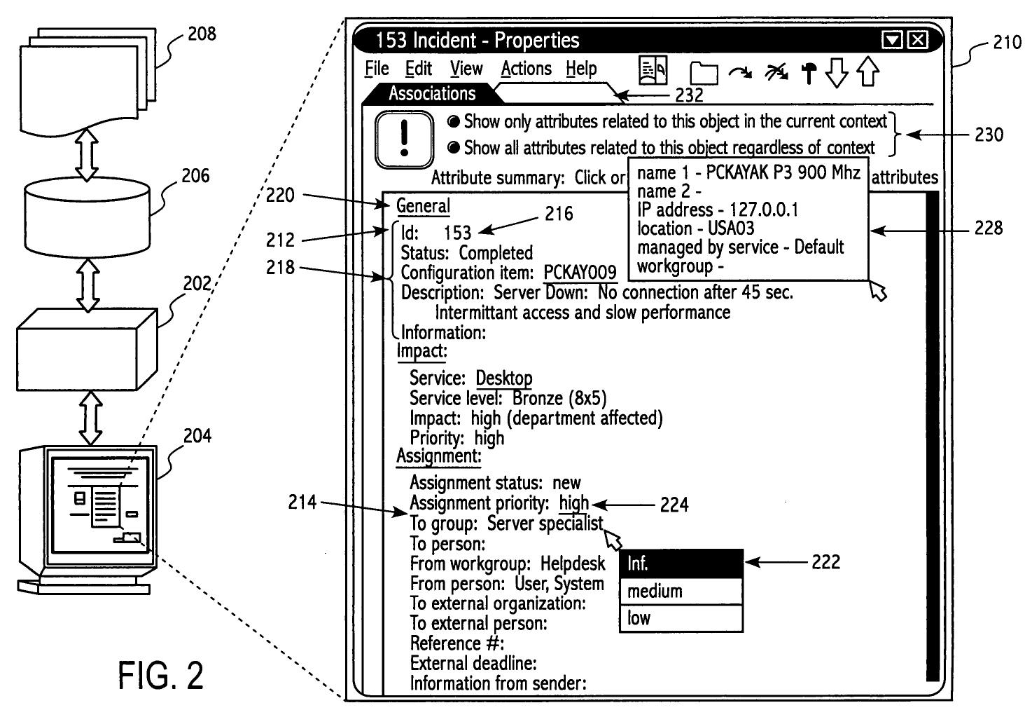

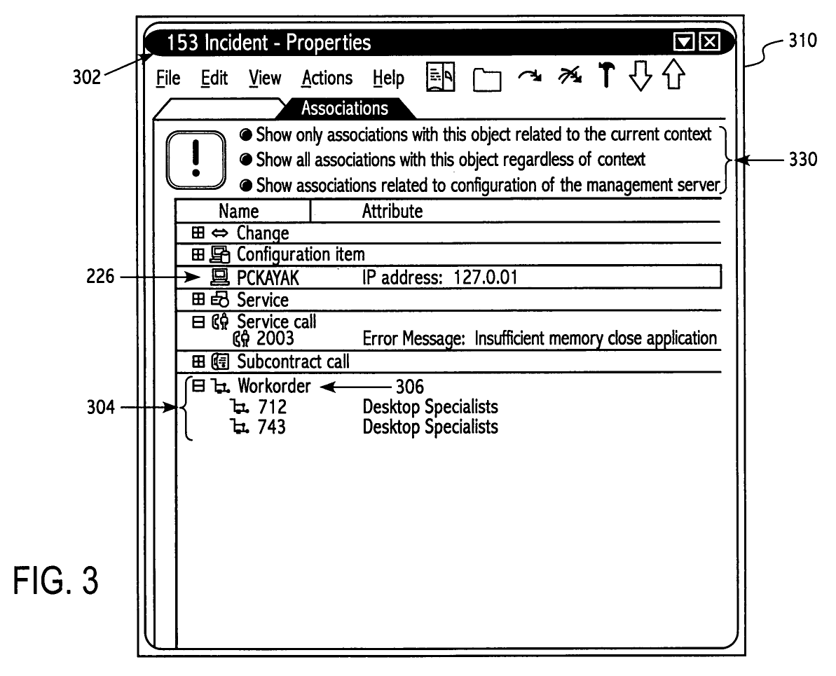

Pages of an exemplary user dialog are shown in FIGS. 2-4. For example, FIG. 2 shows a first page 210 of a user dialog for presenting attributes of a first object managed with a data model 206. FIG. 3 shows a second page 310 of the same user dialog for presenting associations of the first object. The first and second pages 210/310 are displayable on the display 204. It will be understood that the layout of the dialog pages 210/310 is merely illustrative in that dialog pages having different layouts can be used to practice the steps for presenting attributes and/or associations of a first object described in FIG. 1.

In step 102, according to a first exemplary embodiment, a first attribute and a second attribute of the object are collected from the data model. Recall that the data model 206 includes the structure (attributes) and data (attribute values) used by the various application programs 208 of a managed system configured to interface with the data model 206. As such, the data model 206 can be a database that includes the attributes, the attribute values, and other information used by the application programs 208 when executing within the managed environment.

Each of the application programs 208 can store information into the data model 206, and can retrieve information from the data model 206, that has either been stored by the application program itself or by other application programs 208 executing in the environment. The first and second attributes collected from the data model 206 relate to respective application programs 208 configured to use the data model 206. That is, the first attribute relates to the object in the context of the object interfacing with a first application program, and the second attribute relates to the object in the context of the object interfacing with a second application program.

Recall that in an object-oriented data model an application program 208 can use only a portion of the attributes encapsulated within the object. As such, the application program's view of the attributes encapsulated within the object can be limited to only those attributes used by the application program itself. Accordingly, when the properties of an object are examined using a properties dialog or a “tabbed” properties page associated with a single application program, the attributes included in the dialog or page can also be limited to only those attributes used by the single application program. In contrast, the first and second attributes collected from the data model 206 relate to respective application programs, and when displayed together, can provide a broader view of an object's attributes to a user.

In step 104, the first and second attributes are included on a single page of the user dialog. For example, FIG. 2. shows a first attribute 212 and a second attribute 214 included on the first dialog page 210 of the exemplary dialog. The exemplary dialog is a properties dialog for an object in a managed network. The object corresponds to an event (or incident) that has occurred in the managed network. The first attribute 212 describes the identification (Id) of the incident, and has an attribute value 216 of “153”. This attribute can also serve as an identifier for the object, which can be included in the dialog title as “153 Incident—Properties”, although any descriptive title can be used. The first attribute 212 can relate to a first application program configured to monitor and report network incidents to a management station in the network.

FIG. 2 also shows a second attribute 214 included on the first page 210 of the exemplary properties dialog. The second attribute 214 describes the assignment priority of the incident, and has a corresponding attribute value 224 of “high”. The second attribute 214 can relate to a second application program configured to track the resolution of incidents that occur in the managed network. The second attribute 214 can describe the relative priority level assigned to the “153 Incident” as compared to other incidents in the network being tracked by the second application program.

According to exemplary embodiments, a determination can be made as to whether the first attribute 212 is related to the object in a context of a request to present the attributes of the object. If it is determined that the first attribute 212 is related to the object in the context of the request, only then is the first attribute 212 included on the single page of the user dialog. This allows the attribute information included on the first page 210 of the dialog to be filtered based on the context of the request.

For example, if a user affected by the incident were to request the properties of the object, he or she may be interested to know the status of the resolution of the incident, but not necessarily to know the details on the incident report. Accordingly, the first attribute can be “filtered” from the first page 210, and only the second attribute included on the first page 210 in the context of a request by an affected user to present the object properties. In contrast, a network operator can be interested both in the details of the incident report, and in the status of the incident resolution. Accordingly, both the first and second attributes can be included on the first page 210 in the context of a request by a network operator.

The attributes collectable from the data model 206 can exclude some of the total attributes encapsulated in the object. For example, some of the encapsulated attributes can have transient values that only have meaning during a time when an application program is interfacing with the object. These transient-valued attributes can be “trapped” during execution for debugging purpose, but otherwise would add clutter and confusion to the single dialog page displayable to a user or operator, Accordingly, techniques can be used to limit the attributes that are collectable from the data model 206.

For example, a determination can be made as to whether an attribute edit dialog is configured to display an attribute field to prompt an input of an attribute value for the first attribute 212. If it is determined that such an attribute edit dialog exists, only then is the first attribute 212 collected from the data model 206. An attribute edit dialog configured to prompt an input of an attribute value 216 for the first attribute 212 is described in copending U.S. application Ser. No. 11/______ (Attorney Attorney Docket No. 100111123-1), entitled “METHOD AND SYSTEM FOR NAVIGATING A USER DIALOG CONFIGURED TO ACCOMPLISH A TASK”, filed the same day and assigned to the same assignee as this application, the entire contents of which are incorporated by reference. Copending U.S. application Ser. No. 11/______ (Attorney Docket No. 100111124-1), describes a user dialog designed to gather information from a user commonly referred to as a “wizard”. The described dialog can be configured to prompt an input of an attribute value 216 for the first attribute 212.

Other techniques can be used to limit the attributes that are collectable from the data model 206. For example, certain attributes for an object can be “flagged” when being added to the data model 206 to indicate that the “flagged” attributes are collectable from the data model 206. Alternatively, attributes can be captured during the execution of application programs, and thus become collectable from the data model 206. For example, a user can use a “dial-up” telephone connection to connect to a server in a network. The user's telephone number can be captured during the dial-up process and added as attribute of a user object incorporated into the data model 206. Another example can involve a user accessing printer in a network environment. The printer Id can be captured and associated with the user object incorporated into the data model 206.

According to exemplary embodiments, the first attribute can be arranged into a group. The group can include attributes having corresponding attribute fields displayable in the attribute edit dialog. For example, FIG. 2 shows the first attribute 212 arranged into a group 218. The attributes included in the group 218 have corresponding attribute fields displayable in the attribute edit dialog (not shown). Thus, the attribute edit dialog would have fields for collecting attribute values describing the Id, Status, Configuration item, Description, and Information relating to the object. The first attribute 212 and the second attribute 214 need not be arranged into different groups, as shown in FIG. 2. For example, the first and second attributes 212/214 can have corresponding attribute fields included on a same attribute edit dialog and thus be included in the same group 218, but nevertheless relate to respective application programs 208 configured to use the data model 206.

A first software link can be provided between the group 218 and the attribute edit dialog to provide automated access to the attribute edit dialog via the group. The first software link can be a hypertext link associated with the group 218. An exemplary “General” hypertext link 220 is shown in FIG. 2. As will be understood by those skilled in art, when a user positions an input selection device (e.g., a mouse) over the hypertext link 220 and makes a selection (e.g., by “clicking” a mouse button), the corresponding attribute edit dialog (not shown) can be displayed on a computer display, thus providing automated access to the attribute edit dialog via the group 218.

According to exemplary embodiments, a group label can be added to the group 218. The first software link to provide automated access to the attribute edit dialog can then be associated with the group label. For example, the “General” hypertext link 220 described above can also function as a label for the group 218. The group label 220 can describe the general relationship among the attributes included in the group 218. As such, the group label 220 can both describe the attribute values that can be gathered by the attribute edit dialog, and serve as the first software link to provide automated access to the attribute edit dialog via the group 218.

Visual cues can be added to the single page of the dialog to identify the group label 220. “Visual cues”, as used herein, can include any visual attribute of the single dialog page that can be used to distinguish information associated with a particular function or meaning from other information presented on the page. An exemplary list of visual attributes includes a unique relative positioning (i.e., among the information presented on the page, e.g. indenting, tabbing, hierarchical listing, etc.), color (foreground and background), font, orientation, shading, graphics (e.g., 3D), and text attribute (e.g., underlining, italics, bold, case, etc.) of the information to be distinguished on the page. Other visual attributes can include additional text (e.g., labels, headers, footers, footnotes, reference indices) and symbols that can be included to distinguish information presented on the page. It will be understood that the exemplary lists of visual cues provided are not exhaustive.

In the exemplary dialog page 210 shown, several visual cues are used to identify the group label 220. For example, the relative positioning of the first attribute 212 with respect to the group label 220 is offset (or tabbed), producing a hierarchical layout on the page 210. In addition, the group label 220 is presented using a unique foreground color (e.g., blue), and an underlining text attribute. These visual cues are customary in identifying hypertext links, which the group label 220 can also serve as in the exemplary dialog page 210.

While exemplary embodiments have been described associating the first software link with a group label (e.g., the group label 220), it will be understood that the first software link between the group 218 and the attribute edit dialog can be associated with any information included in the group 218 that is presented on the first dialog page 210.

The first attribute 212 can also be modifiable from within the user dialog. A second software link can be provided between the first attribute and a control to provide an input of an attribute value for the first attribute. An exemplary control is illustrated in the first dialog page 210 shown in FIG. 2. The exemplary control is a multiple selection list box 222, and is linked via the second software link to the second attribute 214, but can be linked to any modifiable attribute presented on the first dialog page 210. In the example, the second software link is associated with the second attribute value 224. The exemplary multiple selection list box 222 allows the second attribute value 224 to be modified, e.g., by a network administrator, to change the Assignment priority from “high” to “medium” or “low”.

Visual cues can be added to the single page of the user dialog to identify the modifiable first attribute. In the exemplary first dialog page 210 shown in FIG. 2, the second attribute value 224 is presented using a specific foreground color (e.g., blue) and text underlining. Again, these visual cues are customary for identifying hypertext links. In order to distinguish the second software link associated with the modifiable attribute value 224 from the first software link associated with a group label (e.g., group label 220), the relative positioning of the second attribute value 224 is set such that it is aligned with other attribute values included in a group (e.g., the group 218).

When the user positions the mouse over the modifiable attribute value 224 and begins a selection (e.g., by “clicking” and “holding” a mouse button), the control 222 can then be displayed, offering a list of possible choices for the attribute value 224. The user can then “drag” (moving the mouse while holding the mouse button down) to the desired choice, and release the mouse button to make the selection. Visual cues, such as the background coloring/shading can be added to the control 222 to indicate the user's choice (e.g., “high”). Other controls that can be presented for defining attribute values include text fields and combination boxes, but the list is not exhaustive.

The value of the first attribute can be an object, itself having properties (e.g., attributes and associations). A third software link can be provided between the first attribute and a properties dialog configured to display attributes of the object identified by the first attribute. The third software link can provide automated access to the properties dialog via the first attribute.

An exemplary attribute object 226 is illustrated in FIG. 2. The exemplary attribute object 226 defines the Configuration item (or Information Technology [IT] component) that is the source of the incident occurring in the managed network. Visual cues can be added to the summary to identify the linked attribute object 226. For example, in FIG. 2 the attribute object 226 is presented on the first dialog page 210 using a specific foreground color (e.g., blue) and text underlining. Again, these visual cues are customary for identifying hypertext links. In order to distinguish the third software link associated with the object 226 from the second software link associated with the modifiable first attribute 212, an additional visual cue, such as text bolding, can be added to identify that the attribute value is an object.

When a user positions a mouse over the object 226, and makes a selection (e.g., by “right-clicking”), a properties dialog for the object can be displayed. The properties dialog can be similar to the exemplary properties dialog shown in FIG. 2. If the user positions a mouse over the object 226 for a specified duration, but does not make a selection, a tool-tip 228 can be displayed on the first page 210 of the dialog. The tool-tip 228 can provide a summary of the attributes (or key attributes) of the object 226. For example, the exemplary tool-tip 226 shown in FIG. 2 displays attributes defining the name, IP address, location, managing service, and workgroup of the Configuration item.

FIG. 1 also illustrates the steps for presenting associations of a first object managed within the data model 206. The associations can be presented on a second page of the user dialog introduced in FIG. 2. For example, FIG. 3 shows a second page 310 of the user dialog for presenting associations of the first object identified as “153 Incident”. The second page 310 is displayable on the display 204.

In step 102, according to a second exemplary embodiment, an identity of a second object associated with the first object is collected from the data model. The first and second objects relate to respective application programs 208 configured to use the data model 206. That is, the first object interfaces with a first application program and the second object interfaces with a second application program within the data model.

Recall in object-oriented data models that object association information typically is separately collected and maintained by the various application programs running within the managed environment. This arrangement can require users to navigate through several different user dialogs, corresponding to each of the various application programs, to collect the object association information that they require. In contrast, the first and second objects collected from the data model 206 relate to respective application programs, and when displayed together, can provide a broader view of the object associations existent in the data model 206 to a user.

In step 104, identities of the first and second objects are included on a single page of the user dialog. For example, FIG. 3 shows identities of the first object 302, “153 Incident”, corresponding to the incident occurring in the managed network, and the second object 226, “PCKAYAK”, corresponding to the IT component that is the source of the incident, included on the second dialog page 310. In the example, the identity of the first object 302 is presented as the title of the dialog, as the user has requested object associations of the first object. But it will be understood that the identity of the first object 302 can be included anywhere on the single page of the dialog. Recall that the first object 302 can relate to a first application program configured to monitor and report network incidents to a management station in the network. The second object 226 can relate to a second application configured to maintain an inventory of the IT components included in the managed network.

According to exemplary embodiments, a determination can be made as to whether the second object 226 is associated with the first object 302 in a context of a request to present the associations of the first object 302. If it is determined that the second object 226 is related to the first object 302 in the context of the request, only then is the second object 226 included on the single page of the user dialog. This allows the object association information included on the second page 310 of the dialog to be filtered based on the context of the request.

For example, a user affected by the incident may not be interested in knowing the identity of the IT component that is the source of the incident, so the second object 226 can be “filtered” from the second page 310 of the dialog in the context of a “user request”. In contrast, a network operator can be interested in knowing the identity of the IT component that is the source of the incident, and thus the second object 226 can be included on the second page 310 in the context of a “network operator request”.

The object identities collectable from the data model 206 can exclude some of the total objects associated with the first object 302 in the data model 206. For example, some of the objects included in the data model 206 can have such an attenuated association with the first object 302 that including their identities in the dialog could be confusing to a user. Accordingly, techniques can be used to limit the object identities that are collectable from the data model 206.

For example, a determination can be made as to whether an association edit dialog is configured to display an association field to prompt an input of an identity of an object associated with the second object 226. If it is determined that such an association edit dialog exists, only then is the identity of the second object 226 collected from the data model 206.

Other techniques can be used to limit the identities of objects that are collectable from the data model 206. For example, certain objects can be “flagged” when being added to the data model 206 to indicate that the identities of the “flagged” objects are collectable from the data model 206. Alternatively, object identities can be captured during the execution of application programs, and thus become collectable from the data model 206. For example, a user can access a printer in a network environment from a network terminal. Attributes of the printer can be captured and the printer added to the data model 206 as an object, and associated with an object in the data model 206 corresponding to the network terminal.

According to exemplary embodiments, the second object can be arranged into a group of related objects. The group can include attributes having corresponding attribute fields displayable in the attribute edit dialog. For example, FIG. 3 shows a group 304 of two related objects. The two related objects correspond to individual work orders, e.g., numbers “712” and “743”, which can represent two repair tasks that must be completed to resolve the network incident.

A group label describing the related objects included in a group can be added. For example, the group 304 includes a group label 306 “Workorder”, that identifies that the group 304 includes work order objects. One of the attributes of each of the related objects can be included in the group 304. For example, the second dialog page 310 shown in FIG. 3 includes attributes indicating the work orders are assigned to a “Desktop Specialists” group for resolution. A determination can be made as to whether the second object and related objects share an attribute. If the second object and related objects share an attribute, the shared attribute can be identified in the group label. For example, in the dialog page 310 shown in FIG. 3, the group label 306 can be modified to include the shared attribute “Desktop Specialists”, e.g., the group label can be modified to read “Workorder—Desktop Specialists”.

FIG. 1 also illustrates the steps for presenting both attributes and associations of a first object managed within the data model 206. The attributes and associations are displayable on respective pages of a user dialog. In step 102, according to a third exemplary embodiment, a first attribute and a second attribute of the first object and an identity of a second object associated with the first object are collected from the data model. Details regarding the collection of attributes and associations from the data model are described above in conjunction with the first and second exemplary embodiments illustrated in FIG. 1.

The first and second attributes and objects each relate to respective application programs configured to use the data model. That is, the first attribute relates to the first object in the context of the first object interfacing with a first application program, and the second attribute relates to the first object in the context of the first object interfacing with a second application program. Moreover, the first object interfaces with a first application program and the second object interfaces with a second application program within the data model. The first attribute and first object can relate to the same first application program, but can relate to different application programs. Likewise, the second attribute and second object can relate to the same second application program, but can relate to different application programs as well.

In step 104, the first and second attributes are included on a first page of the user dialog, and identities of the first and second objects on a second page of the user dialog, Again, details regarding the including of attributes and object identities on the first and second pages of the dialog are described above in conjunction with the first and second exemplary embodiments illustrated in FIG. 1.

In step 106, a first software link is provided between the first page and the second page of the dialog to provide automated access to the second page via the link. For example, FIG. 2 shows a “tab” 232 labeled “Associations” included on the first page 210 of the dialog. The first software link can be associated with the tab 232, such that when a user positions a mouse over the tab 232 and makes a selection (e.g., by “right-clicking”), the second page 310 of the dialog will be displayed, thus providing automated access to the second page 310 via the link. As can be seen in FIG. 3, a second “tab” labeled “Attributes” can be included in the second page 310 of the dialog to provide automated access to the first dialog page 210.

Various aspects of the invention will now be described in connection with exemplary embodiments. To facilitate an understanding of these embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects can be embodied in many different forms, and all such forms are contemplated to be within the scope of what is described. For each of the various aspects, any such form of embodiment can be referred to herein as “logic configured to” perform a described action, or alternatively as “logic that” performs a described action.

An exemplary system for presenting attributes and associations of a first object managed within a data model is shown in FIG. 2. The attributes and associations are displayable in a user dialog. The exemplary system includes a processor 202 and a display 204 configured to display the user dialog. The processor 202 is connected to a data model 206, that can be a database. The data model 206 includes the objects, attributes, and other information used by application programs 208 configured to accomplish various tasks within a managed system.

The processor 202 includes logic configured to collect, from the data model, a first attribute and a second attribute of the first object and an identity of a second object associated with the first object within the data model. The first and second attributes and objects each relate to respective application programs configured to use the data model. Details regarding the collection of attributes and associations from the data model are described above in conjunction with the first, second, and third exemplary embodiments illustrated in FIG. 1.

The processor 202 also includes logic configured to include the first and second attributes on a first page of the user dialog, and identities of the first and second objects on a second page of the user dialog. Again, the details regarding the including of attributes and object identities on the first and second pages of the dialog are described above in conjunction with the first and second exemplary embodiments illustrated in FIG. 1.

Logic is also configured in the processor 202 to provide a first software link between the first page and the second page of the dialog to provide automated access to the second page via the link. Details regarding providing first software between the first and second pages of the dialog are described above in conjunction with the third exemplary embodiment illustrated in FIG. 1.

The processor 202 can include logic configured to determine if the first attribute is related to the first object in a context of a request to present the attributes of the first object. If the first attribute is related to the first object in the context of such a request, only then will the first attribute be included on the first page of the user dialog. A control, such as the multi-selection list 230 shown in FIG. 2, can be used by the logic to determine the scope of the attributes presented on the first dialog page 210.

Additional logic can be configured in the processor 202 to determine if the second object is associated with the first object in a context of a request to present the associations of the first object. If the second object is associated with the first object in the context of such a request, only then will the identity of the second object be included on the second page of the user dialog. A second control, such as the multi-selection list 330 shown in FIG. 3, can be used by the logic to determine the scope of the objects presented on the second dialog page 310.

The processor 202 can also include logic configured to determine if an attribute edit dialog is configured to display an attribute field to prompt an input of an attribute value for the first attribute, and if so, to collect the first attribute from the data model, and logic configured to determine if an association edit dialog is configured to display an association field to prompt an input of an identity of an object associated with the second object, and if so, to collect the identity of the second object from the data model. Attribute and association edit dialogs are discussed in detail in conjunction with the exemplary embodiments illustrated in FIG. 1.

The processor 202 can also include logic configured to arrange the first attribute into a first group, and logic configured to arrange the second object into a second group of related objects. The first group can include attributes having corresponding attribute fields displayable in the attribute edit dialog. Additional logic can be configured to provide a second software link between the first group and the attribute edit dialog to provide automated access to the attribute edit dialog via the first group.

The processor 202 can also include logic configured to add a first group label to the first group and a second group label to the second group. Additional logic can be configured to add visual cues to the first and second pages of the user dialog to identify the first and second group labels. Details regarding the types of visual cues that can be added to the first and second pages of the user dialog to identify the first and second group labels is described above in conjunction with the exemplary embodiments illustrated in FIG. 1. The second software link to provide automated access to the attribute edit dialog can be associated with the first group label.

The processor 202 can also include logic configured to determine if the second object and related objects share an attribute, and if so, to arrange the second object into the second group. Logic can also be configured to identify the shared attribute in the second group label.

The first attribute can be modifiable from within the user dialog. Accordingly, the processor 202 can include logic configured to provide a third software link between the first attribute and a control to provide an input of an attribute value for the first attribute. Additional logic can be configured to add visual cues to the single page of the user dialog to identify the modifiable first attribute.

The first attribute can also identify an object managed within the data model. Accordingly, the processor 202 can include logic configured to provide a fourth software link between the first attribute and a properties dialog configured to display attributes of the object identified by the first attribute. The fourth software link can provide automated access to the properties dialog via the first attribute. Additional logic can be configured to add visual cues to the first page of the user dialog to identify the first attribute.

The steps of a computer program as illustrated in FIG. 1 for presenting attributes and associations of a first object managed within a data model can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for presenting attributes of an object managed within a data model, the attributes being displayable in a user dialog, the method comprising:
collecting, from the data model, a first attribute and a second attribute of the object, the first and second attributes relating to respective application programs configured to use the data model; and
including the first and second attributes on a single page of the user dialog.

2. The method of claim 1, comprising:
determining if the first attribute is related to the object in a context of a request to present the attributes of the object, and if so, including the first attribute on the single page of the user dialog.

3. The method of claim 1, comprising:
determining if an attribute edit dialog is configured to display an attribute field to prompt an input of an attribute value for the first attribute, and if so, collecting the first attribute from the data model.

4. The method of claim 3, comprising:
arranging the first attribute into a group, the group including attributes having corresponding attribute fields displayable in the attribute edit dialog; and
providing a first software link between the group and the attribute edit dialog to provide automated access to the attribute edit dialog via the group.

5. The method of claim 4, comprising:
adding a group label to the group; and
adding visual cues to the single page of the user dialog to identify the group label.

6. The method of claim 5, wherein the first software link to provide automated access to the attribute edit dialog is associated with the group label.

7. The method of claim 1, comprising:
providing a second software link between the first attribute and a control to provide an input of an attribute value for the first attribute, the first attribute being modifiable from within the user dialog; and
adding visual cues to the single page of the user dialog to identify the modifiable first attribute.

8. The method of claim 1, wherein the first attribute identifies an object managed within the data model.

9. The method of claim 8, comprising:
providing a third software link between the first attribute and a properties dialog configured to display attributes of the object identified by the first attribute, the third software link providing automated access to the properties dialog via the first attribute; and
adding visual cues to the single page of the user dialog to identify the first attribute.

10. A method for presenting associations of a first object managed within a data model, the associations being displayable in a user dialog, the method comprising:
collecting, from the data model, an identity of a second object associated with the first object within the data model, the first and second objects relating to respective application programs configured to use the data model; and
including identities of the first and second objects on a single page of the user dialog.

11. The method of claim 10, comprising:
determining if the second object is associated with the first object in a context of a request to present the associations of the first object, and if so, including the identity of the second object on the single page of the user dialog.

12. The method of claim 10, comprising:
determining if an association edit dialog is configured to display an association field to prompt an input of an identity of an object associated with the second object, and if so, collecting the identity of the second object from the data model.

13. The method of claim 10, comprising:
arranging the second object into a group of related objects; and
adding a group label to the group.

14. The method of claim 13, comprising:
determining if the second object and related objects share an attribute, and if so, arranging the second object into the group; and
identifying the shared attribute in the group label.

15. A method for presenting attributes and associations of a first object managed within a data model, the attributes and associations being displayable in a user dialog, the method comprising:
collecting, from the data model, a first attribute and a second attribute of the first object and an identity of a second object associated with the first object within the data model, the first and second attributes and objects each relating to respective application programs configured to use the data model;
including the first and second attributes on a first page of the user dialog, and identities of the first and second objects on a second page of the user dialog; and
providing a first software link between the first page and the second page of the dialog to provide automated access to the second page via the link.

16. A system for presenting attributes and associations of a first object managed within a data model, the attributes and associations being displayable in a user dialog, the system comprising:
a processor, including:
logic configured to collect, from the data model, a first attribute and a second attribute of the first object and an identity of a second object associated with the first object within the data model, the first and second attributes and objects each relating to respective application programs configured to use the data model;
logic configured to include the first and second attributes on a first page of the user dialog, and identities of the first and second objects on a second page of the user dialog; and
logic configured to provide a first software link between the first page and the second page of the user dialog to provide automated access to the second page via the link; and
a display configured to display the user dialog.

17. The system of claim 16, wherein the processor comprises:
logic configured to determine if the first attribute is related to the first object in a context of a request to present the attributes of the first object, and if so, to include the first attribute on the first page of the user dialog; and
logic configured to determine if the second object is associated with the first object in a context of a request to present the associations of the first object, and if so, to include the identity of the second object on the second page of the user dialog.

18. The system of claim 16, wherein the processor comprises:
logic configured to determine if an attribute edit dialog is configured to display an attribute field to prompt an input of an attribute value for the first attribute, and if so, to collect the first attribute from the data model; and
logic configured to determine if an association edit dialog is configured to display an association field to prompt an input of an identity of an object associated with the second object, and if so, to collect the identity of the second object from the data model.

19. The system of claim 18, wherein the processor comprises:
logic configured to arrange the first attribute into a first group, the first group including attributes having corresponding attribute fields displayable in the attribute edit dialog;
logic configured to arrange the second object into a second group of related objects; and
logic configured to provide a second software link between the first group and the attribute edit dialog to provide automated access to the attribute edit dialog via the first group.

20. The system of claim 19, wherein the processor comprises:
logic configured to add a first group label to the first group and a second group label to the second group; and
logic configured to add visual cues to the first and second pages of the user dialog to identify the first and second group labels.

21. The system of claim 20, wherein the processor comprises:
logic configured to determine if the second object and related objects share an attribute, and if so, to arrange the second object into the second group; and
logic configured to identify the shared attribute in the second group label.

22. The system of claim 20, wherein the second software link to provide automated access to the attribute edit dialog is associated with the first group label.

23. The system of claim 16, wherein the processor comprises:
logic configured to provide a third software link between the first attribute and a control to provide an input of an attribute value for the first attribute, the first attribute being modifiable from within the user dialog; and
logic configured to add visual cues to the single page of the user dialog to identify the modifiable first attribute.

24. The system of claim 16, wherein the first attribute identifies an object managed within the data model.

25. The system of claim 24, wherein the processor comprises:
logic configured to provide a fourth software link between the first attribute and a properties dialog configured to display attributes of the object identified by the first attribute, the fourth software link providing automated access to the properties dialog via the first attribute; and
logic configured to add visual cues to the first page of the user dialog to identify the first attribute.

26. A computer-readable medium containing a computer program for presenting attributes and associations of a first object managed within a data model, the attributes and associations being displayable in a user dialog, wherein the computer program performs the steps of:
collecting, from the data model, a first attribute and a second attribute of the first object and an identity of a second object associated with the first object within the data model, the first and second attributes and objects each relating to respective application programs configured to use the data model;
including the first and second attributes on a first page of the user dialog, and identities of the first and second objects on a second page of the user dialog; and
providing a software link between the first and second pages of the user dialog to provide automated access to the first and second pages via the link.
